(19) United States
(12) Patent Application Publication
(10) Pub. No.: US 2026/0138364 A1
(43) Pub. Date: May 21, 2026

(54) INKJET HEAD, CONTROL CIRCUIT, AND INKJET PRINTER

(71) Applicant: RISO Technologies Corporation, Tokyo (JP)

(72) Inventor: Sota HARADA, Mishima Shizuoka (JP)

(21) Appl. No.: 19/271,696

(22) Filed: Jul. 16, 2025

(30) Foreign Application Priority Data
Nov. 20, 2024 (JP) 2024-202561

(51) Int. Cl. B41J 2/045; B41J 2/14

(52) U.S. Cl. CPC B41J 2/0453; B41J 2/04541; B41J 2/04548; B41J 2/14; B41J 2/04586; B41J 2002/14491

(57) ABSTRACT

An inkjet head includes a plurality of actuators each configured to eject ink through a corresponding one of nozzles, the actuators including first actuators corresponding to first nozzles that are enabled to eject ink and second actuators corresponding to second nozzles that are disabled from ejecting ink, a drive circuit configured to drive the actuators in accordance with input data, and a data transfer circuit configured to: acquire first image data associating each of the first nozzles with images to be formed, add, to the first image data, dummy image data associated with the second nozzles, and output the first image data to which the dummy image data has been added to the drive circuit as the input data.

### CROSS-REFERENCE TO RELATED APPLICATION

This application is based upon and claims the benefit of priority from Japanese Patent Application No. 2024-202561, filed on Nov. 20, 2024, the entire contents of which are incorporated herein by reference.

### FIELD

Embodiments described herein relate generally to an inkjet head, a control circuit, and an inkjet printer.

### BACKGROUND

An image forming apparatus such as an inkjet printer which ejects ink onto a print medium to form an image is known. The inkjet printer has, for example, an inkjet head and a head controller which controls the inkjet head.

The inkjet head has, for example, a head unit and an intra-head control circuit. The head unit has an actuator with a plurality of capacitive elements coupled to each other. Further, the intra-head control circuit has a drive circuit or a driver IC which drives the actuator, a control circuit which transmits, to the drive circuit, data such as drive circuit configuration data and print image data transmitted from the head controller, an input-output circuit which inputs and outputs a variety of signals other than the data between the head controller and the drive circuit and the intra-head control circuit. In such an inkjet head, the drive circuit configuration data such as a drive waveform is transmitted to the drive circuit in advance, and the print image data is sequentially transmitted to the drive circuit in accordance with a print synchronization signal.

In recent years, demand for higher printing speed and resolution has been increasing. To achieve higher-speed, higher-resolution printing, it becomes necessary to transmit a large amount of print image data in a short period of time. As one of the countermeasures, there is a method of increasing the data transfer rate from the head controller to the head unit.

However, increasing the data transfer rate makes signal transmission more difficult and raises costs.

### BRIEF DESCRIPTION OF THE DRAWINGS

FIG. 1 is a diagram of an inkjet printer in a first embodiment.

FIG. 2 is a diagram of an inkjet head according to the first embodiment.

FIG. 3 is a diagram of a head controller in the first embodiment.

FIG. 4 is a diagram of a data processing unit in an intra-head control circuit according to the first embodiment.

FIG. 5 is a transition diagram of a data format example of print image data for explaining an operation of the inkjet head.

FIG. 6 is a transition diagram of another data format example of the print image data for explaining the operation of the inkjet head.

FIG. 7 is a diagram of an intra-head control circuit according to a second embodiment.

FIG. 8 is a diagram of a data processing unit in an intra-head control circuit according to a third embodiment.

FIG. 9 is a diagram showing a data format example of nozzle configuration data.

FIG. 10 is a diagram of an intra-head control circuit according to a fourth embodiment.

FIG. 11 is a diagram of a head controller in the fourth embodiment.

### DETAILED DESCRIPTION

Embodiments of the present disclosure provide an inkjet head, a control circuit, and an inkjet printer capable of achieving at low cost an increase in data transfer rate.

In general, according to one embodiment, an inkjet head comprises a plurality of actuators each configured to eject ink through a corresponding one of nozzles, the actuators including first actuators corresponding to first nozzles that are enabled to eject ink and second actuators corresponding to second nozzles that are disabled from ejecting ink; a drive circuit configured to drive the actuators in accordance with input data; and a data transfer circuit configured to: acquire first image data associating each of the first nozzles with images to be formed, add, to the first image data, dummy image data associated with the second nozzles, and output the first image data to which the dummy image data has been added to the drive circuit as the input data.

### First Embodiment

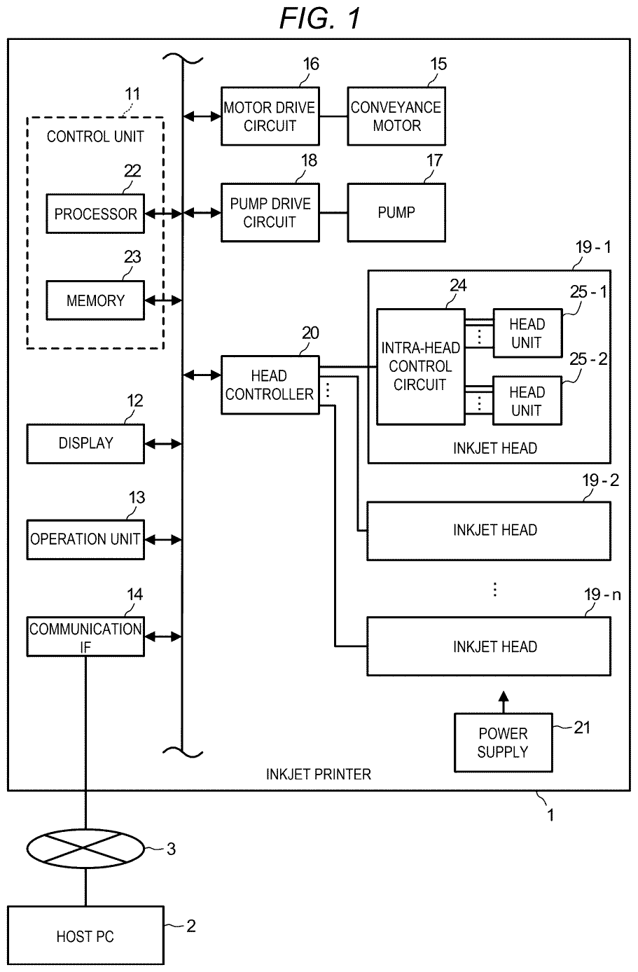

FIG. 1 is a diagram of an inkjet printer 1 in a first embodiment. The inkjet printer 1 performs image formation on a print medium as a recording medium while conveying the print medium.

The inkjet printer 1 includes a control unit 11, a display 12, an operation unit 13, a communication interface 14, a conveyance motor 15, a motor drive circuit 16, a pump 17, a pump drive circuit 18, a plurality of (n; n represents a natural number no smaller than 2) inkjet heads 19-1, 19-2, . . . , and 19-n according to the first embodiment, a head controller 20, and a power supply 21. Further, the inkjet printer 1 includes a conveyance mechanism, a paper cassette, and a catch tray all not shown. It should be noted that “interface” is abbreviated as “IF” in the drawings. Further, in the following description, the plurality of inkjet heads 19-1 to 19-n are described simply as “inkjet head 19” when describing the plurality of inkjet heads 19-1 to 19- n without distinction.

The control unit 11 includes a processor 22 and a memory 23 to perform a variety of types of control of the inkjet printer 1. The processor 22 is an arithmetic element which executes arithmetic processing. The processor 22 performs a variety of types of processing based on a program and data to be used in the program stored in, for example, the memory 23. The memory 23 stores the program, the data to be used in the program, and so on in a rewritable manner.

The display 12 is a display device such as a liquid crystal display, and displays an image in accordance with a video signal input from the processor 22, a graphic controller, not shown, for performing image processing, or the like.

The operation unit 13 has a device which generates an operation signal based on an operation of a user. The operation unit 13 is, for example, a touch sensor, a numerical keypad, a power key, a paper feed key, a variety of function keys, or a keyboard. The touch sensor is, for example, a resistive-film touch sensor or a capacitive touch sensor. The touch sensor acquires information representing a position designated in a certain region. Further, the touch sensor may be a touch panel which is integrated into the display 12 and disposed on an upper surface of the display 12. In this case, the touch sensor generates a signal representing a touched position on a screen displayed on the display 12.

The communication interface 14 is an interface circuit which communicates with an external apparatus. In the present embodiment, the communication interface 14 is used, for example, for communication with at least one host PC 2 which transmits print data to the inkjet printer 1. The communication interface 14 communicates with the host PC 2 via a network 3 configured with wired or wireless communication, such as a local area network (LAN).

The conveyance motor 15 rotates to thereby function as a drive source for a conveyance mechanism, not shown, for conveying the print medium. The conveyance mechanism is constituted by a conveyance belt for conveying the print medium, a plurality of rollers (e.g., a drive roller and a driven roller) which support the conveyance belt, a guide, and so on. The conveyance motor 15 rotates the drive roller to move the conveyance belt. The print medium moves on the conveyance path defined as the guide arranged around the conveyance belt.

The motor drive circuit 16 drives the conveyance motor 15 in accordance with a conveyance control signal input from the control unit 11. Due to the motor drive circuit 16, the conveyance motor 15, and the conveyance mechanism, the print medium picked up from the paper cassette not shown is conveyed to the catch tray not shown via the plurality of inkjet heads 19. It should be noted that the paper cassette is a cassette for storing a plurality of print media. The catch tray is a tray for holding the print medium discharged from the inkjet printer 1.

The pump 17 supplies ink to ink chambers of the inkjet heads 19 from an ink tank via an ink supply flow channel. The pump 17 is disposed on an ink supply flow path formed of a tube not shown which couples the ink tank and the ink chamber (a pressure chamber) of the inkjet head 19.

The pump drive circuit 18 drives the pump 17 in accordance with an ink supply control signal input from the processor 22.

The inkjet heads 19 eject the ink to the print medium to form an image. Based on drive power and control signals supplied from the head controller 20, the inkjet heads 19 eject the ink to the print medium conveyed to the conveyance mechanism to thereby form the image. The plurality of inkjet heads 19 is disposed for colors of the ink so as to correspond to the colors such as cyan, magenta, yellow, and black. It should be noted that one set of the pump 17 and the pump drive circuit 18 is shown alone in FIG. 1 in order to simplify the drawing, but at least one set may be provided to each color, and the set may be provided so as to correspond to each of the plurality of inkjet heads 19.

Each of the inkjet heads 19 has the intra-head control circuit 24 according to the first embodiment, and a plurality of head units, two head units 25-1, 25-2 in the present embodiment. In the following description, the two inkjet heads 25-1, 25-2 are described simply as “head units 25” when describing the two inkjet heads 25-1, 25-2 without distinction. The head unit 25 has a plurality of channels for ejecting ink. Each of the channels is provided with a nozzle for ejecting the ink, the pressure chamber communicated with the nozzle, and an actuator for changing a volume of the pressure chamber. The intra-head control circuit 24 controls this head unit 25. The intra-head control circuit 24 includes a drive circuit which selects the channel for ejecting the ink out of the plurality of channels of the head unit 25 to apply the drive signal to the actuator to drive the drive circuit. When the actuator of the head unit 25 is driven, the volume of the pressure chamber filled with the ink changes to eject the ink from the nozzle.

The head controller 20 is a circuit which is coupled to the control unit 11, the power supply 21, and the host PC 2 to control the plurality of inkjet heads 19 coupled thereto. The head controller 20 causes the actuators in the inkjet heads 19 to eject ink to form the image on the print medium.

The power supply 21 converts the AC power supplied from the commercial power supply into DC power (a DC voltage DCV). The power supply 21 supplies the DC power to each configuration unit in the inkjet printer 1 as the drive power.

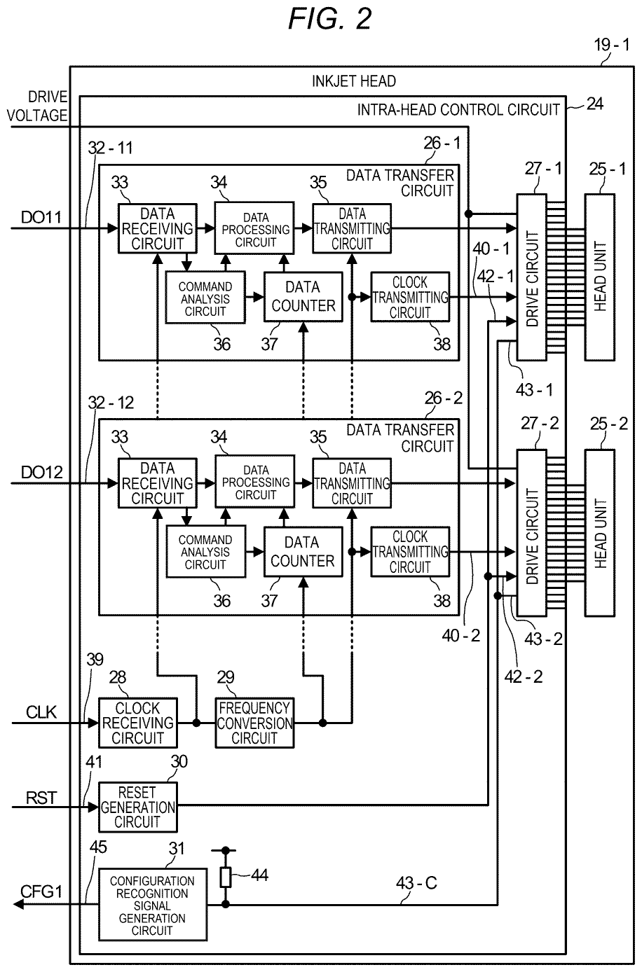

The inkjet heads 19 and the head controller 20 will hereinafter be described in detail. First, the inkjet heads 19 will be described with reference to FIG. 2. FIG. 2 is a diagram of the inkjet head 19-1 according to the first embodiment. It should be noted that FIG. 2 just shows the inkjet head 19-1 as a representative out of the plurality of inkjet heads 19, and other inkjet heads 19-2 to 19-n have substantially the same configuration.

As described above, the two head units 25-1, 25-2 are coupled to the intra-head control circuit 24.

The intra-head control circuit 24 has data transfer circuits 26-1, 26-2, drive circuits 27-1, 27-2, and an input-output circuit, and the input-output circuit includes a clock receiving circuit 28, a frequency conversion circuit 29, a reset generation circuit 30, and a configuration recognition signal generation circuit 31. The data transfer circuit 26-1 and the drive circuit 27-1 correspond to the head unit 25-1, and the data transfer circuit 26-2 and the drive circuit 27-2 correspond to the head unit 25-2. In the following description, when the data transfer circuits 26-1, 26-2 are described simply as “data transfer circuits 26” when being described without distinction, and the drive circuits 27-1, 27-2 are described simply as “drive circuits 27” when being described without distinction.

The data transfer circuit 26-1 has a configuration for controlling the drive circuit 27-1 based on data input from the head controller 20 via a data input path 32-11 coupled to an inkjet head high-speed data transmission path DO11. Similarly, the data transfer circuit 26-2 has a configuration for controlling the drive circuit 27-2 based on data input from the head controller 20 via a data input path 32-12 coupled to an inkjet head high-speed data transmission path DO12. In the following description, the data input paths 32-11, 32-12 are described simply as “data input paths 32” when being described without distinction.

The data transfer circuit 26 includes a data receiving circuit 33, a data processing circuit 34, a data transmitting circuit 35, a command analysis circuit 36, a data counter 37, and a clock transmitting circuit 38. One or more of those circuits may be implemented by software such that the corresponding functions can be performed by a processor.

The data receiving circuit 33 receives a variety of types of data from the head controller 20 via the data input path 32 in synchronization with the data receiving clock. The data receiving clock is input from the clock receiving circuit 28. That is, the clock receiving circuit 28 receives a clock which is input from the head controller 20 via a clock signal input path 39 coupled to a clock signal transmitting transmission path CLK, and which is synchronized with the data, and then input the clock thus received to the data receiving circuit 33 of each of the data transfer circuits 26 as a data receiving clock. Further, the clock receiving circuit 28 inputs the data receiving clock to the frequency conversion circuit 29. The data receiving circuit 33 transfers the data thus received to the data processing circuit 34 and the command analysis circuit 36. It should be noted that the data received by the data receiving circuit 33 includes a start bit followed by a command and a data substance corresponding to that command.

The command analysis circuit 36 analyzes the command contained by the data transferred from the data receiving circuit 33, and then inputs the analysis result to the data processing circuit 34. The command includes a print command which instructs printing, and a configuration command which instructs configurations of the drive circuit 27. The print image data includes a print command and image data as the data substance. The drive circuit configuration data include a configuration command and configuration data as the data substance.

Further, when the analysis result is the print command, the command analysis circuit 36 starts up the data counter 37 from when starting the reception of the image data as the data substance. The data counter 37 counts the data transmitting clock. The data transmitting clock is a print synchronization signal, and is input from the frequency conversion circuit 29. The frequency conversion circuit 29 is configured with a phase locked loop (PLL), a delay locked loop (DLL), or the like, and converts a frequency of the data receiving clock into a higher frequency to thereby generate the data transmitting clock.

When the analysis result input from the command analysis circuit 36 is the configuration command or the like, the data processing circuit 34 transfers, to the data transmitting circuit 35, the drive circuit configuration data or the like transferred from the data receiving circuit 33. Further, when the analysis result is the print command, the data processing circuit 34 adds a correction to the print image data based on the count of the data counter 37, and then transfers the print image data thus corrected to the data transmitting circuit 35. The correction on the print image data in the data processing circuit 34 is processing of adding the image data of a fixed value to the print image data, and the details thereof will be described later.

The data transmitting circuit 35 transfers, to the drive circuit 27, the data transferred from the data processing circuit 34 in synchronization with the data transmitting clock as the print synchronization signal.

Further, the data transmitting clock converted by the frequency conversion circuit 29 is input to the clock transmitting circuit 38, and the clock transmitting circuit 38 transfers the data transmitting clock to the drive circuit 27. Specifically, the clock transmitting circuit 38 of the data transfer circuit 26-1 inputs the data transmitting clock to the drive circuit 27-1 via a clock signal output path 40-1. Further, the clock transmitting circuit 38 of the data transfer circuit 26-2 inputs the data transmitting clock to the drive circuit 27-2 via a clock signal output path 40-2.

The drive circuit 27 is a driver IC in which dedicated drive circuits for driving a plurality of actuators of the head unit 25 are integrated with each other. The drive circuit 27 generates the drive signal as an analog signal to be applied to each of the actuators using a drive voltage from the head controller 20 based on the drive circuit configuration data and the print image data as the data from the data processing circuit 34 and the data transmitting clock from the clock transmitting circuit 38, and then applies the drive signal to thereby drive each of the actuators.

The reset generation circuit 30 receives a reset signal which is input from the head controller 20 via a reset signal input path 41 coupled to a reset signal transmitting transmission path RST, removes chattering to generate the reset signal common to the drive circuits 27. The reset generation circuit 30 inputs the common reset signal thus generated to the drive circuit 27-1 via a reset signal output path 42-1, and inputs the common reset signal thus generated to the drive circuit 27-2 via a reset signal output path 42-2. In this way, by inputting the common reset signal to each of the drive circuits 27, it is possible to reset the plurality of drive circuits 27 at the same time. Each of the drive circuits 27 thus reset can perform initial setting based on the drive circuit configuration data input from the data transmitting circuit 35.

When the initial setting of the drive circuit 27-1 is completed to be in an available state, the drive circuit 27-1 inputs a configuration recognition signal to the configuration recognition signal generation circuit 31 via a configuration recognition signal input path 43-1. Similarly, when the initial setting of the drive circuit 27-2 is completed to be in an available state, the drive circuit 27-2 inputs the configuration recognition signal to the configuration recognition signal generation circuit 31 via a configuration recognition signal input path 43-2. In the present first embodiment, since the drive circuits 27 output the signals with open-drain circuits, the configuration recognition signal input path 43-1 and the configuration recognition signal input path 43-2 combine the configuration recognition signals on a signal input path to input the configuration recognition signals to the configuration recognition signal generation circuit 31. In this case, a configuration recognition signal input path 43-C thus combined is coupled to a predetermined power supply line via a pull-up resistor 44. When all the configuration recognition signals are provided to the configuration recognition signal generation circuit 31, the configuration recognition signal generation circuit 31 outputs the configuration recognition signal to a configuration recognition signal output path 45 coupled to a configuration recognition signal receiving path CFG1 to the head controller 20. On this occasion, the configuration recognition signal generation circuit 31 removes chattering of the configuration recognition signal which is transferred through the configuration recognition signal input path 43-C, that is, the configuration recognition signal input path 43-1 and the configuration recognition signal input path 43-2 to thereby generate the configuration recognition signal to be output to the configuration recognition signal output path 45. In this way, the inkjet head 19-1 notifies the head controller 20 of the fact that the initial setting is completed and the available state is achieved in all of the drive circuits 27 of the inkjet head 19-1.

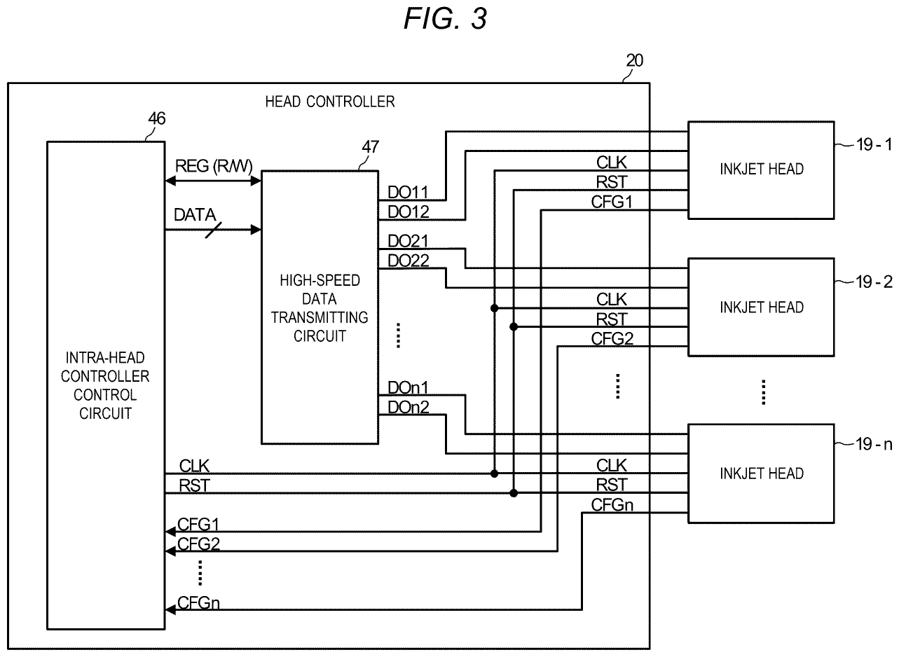

Then, the head controller 20 will be described in more detail with reference to FIG. 3. FIG. 3 is a diagram of the head controller 20. It should be noted that FIG. 3 only shows a configuration of a part related to the inkjet head high-speed data transmission path and some signal communication paths.

The head controller 20 is a head control circuit which provides a command to the plurality of inkjet heads 19 via the respective inkjet head high-speed data transmission paths DOi1, DOi2 (where i=1 to n) to thereby control operations of the plurality of inkjet heads 19. The head controller 20 is provided with an intra-head controller control circuit 46 and a high-speed data transmitting circuit 47.

The intra-head controller control circuit 46 is a microcomputer having an internal memory. The intra-head controller control circuit 46 is coupled to each of the inkjet heads 19 via the clock signal transmitting transmission path CLK coupled in common, and the reset signal transmitting transmission path RST similarly coupled in common. Further, the intra-head controller control circuit 46 is coupled to each of the plurality of inkjet heads 19 via respective individual configuration recognition signal receiving paths CFG1 to CFGn. Further, the intra-head controller control circuit 46 is coupled to the high-speed data transmitting circuit 47 with a register read-write line REG (R/W) and data lines DATA.

The high-speed data transmitting circuit 47 is a serializer which is coupled to each of the plurality of inkjet heads 19 via the individual inkjet head high-speed data transmitting paths DOi1, DOi2, respectively. The high-speed data transmitting circuit 47 transmits data from the intra-head controller control circuit 46 to the inkjet head 19 as the destination via the inkjet head high-speed data transmission path. Here, out of the inkjet head high-speed data transmission paths, the inkjet head high-speed data transmission path DOi1 transmits data for the head unit 25-1 out of the two head units 25-1, 25-2 in the inkjet head 19, and the inkjet head high-speed data transmission path DOi2 transmits data for the head unit 25-2.

It should be noted that the number of nozzles, that is, the number of actuators, provided to the head unit 25 and the number of actuator output terminals of the drive circuit 27 are not necessarily required to coincide with each other. For example, as shown in FIG. 2, the number of actuator output terminals of the drive circuit 27 may be larger, and there may be the disabled actuator output terminal which is not coupled to the actuator of the head unit 25. Further, although the number of actuator output terminals and the number of actuators coincide with each other, it is also possible to provide an actuator output terminal of the drive circuit 27 to which only the drive signal that does not actually drive the actuator is applied. In such a case, dummy unused image data is applied as the image data corresponding to the disabled actuator output terminal which is not coupled to the actuator or which only outputs the drive signal which does not result in the actual drive of the actuator, and the print image data to which such unused image data is applied is input to the drive circuit 27.

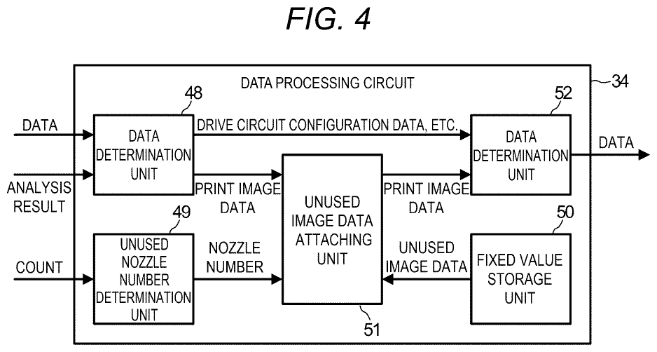

The application of such dummy unused image data will hereinafter be described with reference to FIG. 4. FIG. 4 is a diagram showing a configuration example of the data processing circuit 34 in an intra-head control circuit 24 according to the first embodiment. The data processing circuit 34 performs the functions of a data determination unit 48, a data determination unit 52, an unused image data attaching unit 51, an unused nozzle number determination unit 49, and a fixed value storage unit 50. Those units may be implemented by hardware such as circuits and/or software.

The data determination unit 48 receives the data from the data receiving circuit 33 and an analysis result from the command analysis circuit 36, and then transfers the data thus input to the data determination unit 52 or the unused image data attaching unit 51 based on the analysis result. For example, the data determination unit 48 may be configured as a demultiplexer. When the analysis result is the print command, the data determination unit 48 transfers the data thus input to the unused image data attaching unit 51 assuming that the print image data is input from the data receiving circuit 33, that is, from the processor 22 of the inkjet printer 1 via the head controller 20. When the analysis result is the configuration command or the like, the data determination unit 48 transfers the drive circuit configuration data thus input to the data determination unit 52 assuming that the drive circuit configuration data were input.

The unused nozzle number determination unit 49 receives the count counted by the data counter 37, and then outputs the count value to the unused image data attaching unit 51 as the nozzle number.

The fixed value storage unit 50 stores a fixed value to be the unused print image data.

The unused image data attaching unit 51 is provided with, as known information, an unnecessary nozzle number representing the nozzle which is not used for printing the print image data in the head unit 25, that is, the disabled actuator output terminal which is not coupled to the actuator or which only outputs the drive signal which does not result in the actual drive of the actuator out of the actuator output terminals of the drive circuit 27. As described above, in the present first embodiment, which actuator output terminal is the terminal corresponding to the unnecessary nozzle number is uniquely determined for the head unit 25 provided to the inkjet head 19.

The unused image data attaching unit 51 selects either one of the print image data input from the data determination unit 48 and the unused image data input from the fixed value storage unit 50 based on the nozzle number input from the unused nozzle number determination unit 49, and then transfers the image data thus selected to the data determination unit 52 as the print image data. For example, the unused image data attaching unit 51 may be configured as a multiplexer. When the nozzle number corresponding to the unnecessary nozzle number provided as the known information is input, the unused image data attaching unit 51 transfers the fixed value as the unused image data input from the fixed value storage unit 50 to the data determination unit 52 as the print image data. When the nozzle number which does not correspond to the unnecessary nozzle number is input, the unused image data attaching unit 51 transfers the print image data input from the data determination unit 48 to the data determination unit 52 as the print image data. In this way, when the nozzle number coincides with the unnecessary nozzle number, the unused image data attaching unit 51 generates the print image data obtained by attaching the unused image data as the fixed value to the print image data, and then transfers the print image data thus generated to the data determination unit 52. It should be noted that as described above, since the count input to the unused nozzle number determination unit 49 is what is obtained by counting the data transmitting clock lower in frequency than the data receiving clock, the print image data input to the unused image data attaching unit 51 and the nozzle number are not synchronized with each other. Since the unused image data attaching unit 51 generates the image data based on the nozzle number, the image data to be transferred to the data determination unit 52 is made synchronized with the data transmitting clock.

The data determination unit 52 transfers the drive circuit configuration data transmitted from the data determination unit 48 and the print image data transmitted from the unused image data attaching unit 51 to the data transmitting circuit 35 in the posterior stage. For example, the data determination unit 52 may be configured as a multiplexer. The data determination unit 52 transfers the drive circuit configuration data to the data transmitting circuit 35 when the drive circuit configuration data are transferred from the data determination unit 48, and transfers the print image data to the data transmitting circuit 35 when the print image data is transferred from the unused image data attaching unit 51.

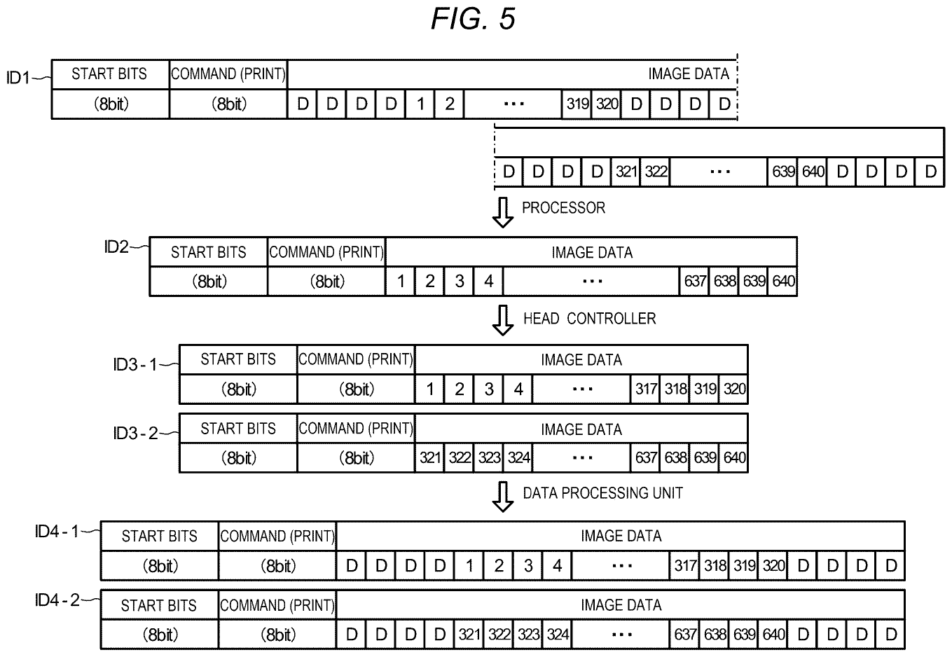

An operation of the inkjet head 19 according to the first embodiment will hereinafter be described with reference to FIG. 5. FIG. 5 is a transition diagram of a data format example of the print image data for explaining the operation of the inkjet head 19. It should be noted that FIG. 5 shows the print image data in which one line corresponds to 640 dots, and is an example in which printing is performed with two head units 25 via two drive circuits 27 each having 328 actuator output terminals. Here, the head unit 25 has, for example, 320 nozzles each performing 1 dot printing, and the starting four disabled actuator output terminals and the last four disabled actuator output terminals out of the 328 actuator output terminals are not coupled to the nozzles of the head unit 25. Alternatively, it is possible to provide the head unit 25 to have no less than 321 nozzles, such as 328 nozzles, which is the same in the number as the 328 actuator output terminals of the drive circuit 27, and the nozzles are respectively coupled to the actuator output terminals, but only 320 nozzles out of those nozzles are valid while the starting four nozzles and the last four nozzles are the dummy nozzles which are not used, and only the drive signals which do not result in the actual drive of the actuators are output from the actuator output terminals corresponding to those dummy nozzles of the drive circuit 27.

When using the inkjet head 19 having such a configuration, the processor 22 of the inkjet printer 1 supplied print image data such as print image data ID1 to the head controller 20 in the related art. In the print image data ID1, an 8-bit print command representing the fact that the present data is print image data is disposed subsequently to 8-bit start bits, and image data to be printed which is the data substance is arranged subsequently thereto. In the image data, dummy data D having a fixed value as the unused image data is set to the bits corresponding to the actuator output terminals of the drive circuit 27 which are not coupled to the actuators of the head unit 25 or which only output the drive signals which do not result in the actual drive of the actuators. Used image data corresponding to 640 dots corresponding to nozzle numbers #1 to #640 is set to bits of the image data which output the drive signals making a contribution to the drive of the actuators.

In contrast, in the present first embodiment, the processor 22 generates print image data ID2 which does not include such dummy data D, and then supplies the print image data ID2 to the head controller 20. Then, the head controller 20 generates the print image data to be transmitted to each of the inkjet heads 19 from the print image data ID2. Specifically, the head controller 20 generates, for example, two print image data ID3-1, ID3-2 to be transferred to the inkjet head 19-1. The print image data ID3-1 is the print image data which is transmitted to the data transfer circuit 26-1 of the intra-head control circuit 24 of the inkjet head 19-1 via the inkjet head high-speed data transmission path DO11. The print image data ID3-2 is the print image data which is transmitted to the data transfer circuit 26-2 of the intra-head control circuit 24 of the inkjet head 19-1 via the inkjet head high-speed data transmission path DO12. The print image data ID3-1 includes the used image data corresponding to 320 dots corresponding to the nozzle numbers #1 to #320 subsequently to the 8-bit start bits and the 8-bit print command. The print image data ID 3-2 includes the used image data corresponding to 320 dots corresponding to the nozzle numbers #321 to #640 subsequently to the 8-bit start bits and the 8-bit print command. It should be noted that in the following description, the print image data ID3-1, ID3-2 is described simply as “print image data ID3” when describing the print image data ID3-1, ID3-2 without distinction.

In the intra-head control circuit 24 of the inkjet head 19 which receives such print image data ID3, the fact that the data input is the print image data ID3 is determined with the command analysis circuit 36, and the dummy data D having the fixed value as the unused image data is attached to the print image data ID3 with the data processing circuit 34.

Specifically, in the data processing circuit 34 of the data transfer circuit 26-1, when the analysis result from the command analysis circuit 36 is the print command, that is, when the data thus input is the print image data ID3-1, the data determination unit 48 transfers the data thus input to the unused image data attaching unit 51.

The unused nozzle number determination unit 49 outputs the nozzle number to the unused image data attaching unit 51 in accordance with the count from the data counter 37.

When the nozzle numbers #1 to #4 and the nozzle numbers #325 to #328 which are the nozzle numbers corresponding to the unnecessary nozzle numbers provided as the known information from the unused nozzle number determination unit 49 are input, the unused image data attaching unit 51 attaches the dummy data D having the fixed value as the unused image data stored in the fixed value storage unit 50 to the image data as the data substance of the print image data ID3-1 input from the data determination unit 48. In this way, the unused image data attaching unit 51 generates the print image data ID4-1 obtained by attaching the four dummy data D before and after the used image data corresponding to the 320 dots corresponding the nozzle numbers #1 to #320 of the print image data ID3-1. The unused image data attaching unit 51 transfers the print image data ID4-1 to the drive circuit 27-1 via the data determination unit 52.

Similarly, in the data processing circuit 34 of the data transfer circuit 26-2, when the nozzle numbers #321 to #324 and the nozzle numbers #645 to #648 which are the nozzle numbers set as the unnecessary nozzle numbers with the known information by the unused nozzle number determination unit 49 are input, the unused image data attaching unit 51 attaches the dummy data D having the fixed value as the unused image data stored in the fixed value storage unit 50 to the image data as the data substance of the print image data ID3-2 input from the data determination unit 48. In this way, the unused image data attaching unit 51 generates the print image data ID4-2 obtained by attaching the four dummy data D before and after the used image data corresponding to the 320 dots corresponding the nozzle numbers #321 to #640 of the print image data ID3-2, and then, transfers the print image data ID4-2 thus generated to the drive circuit 27-2 via the data determination unit 52.

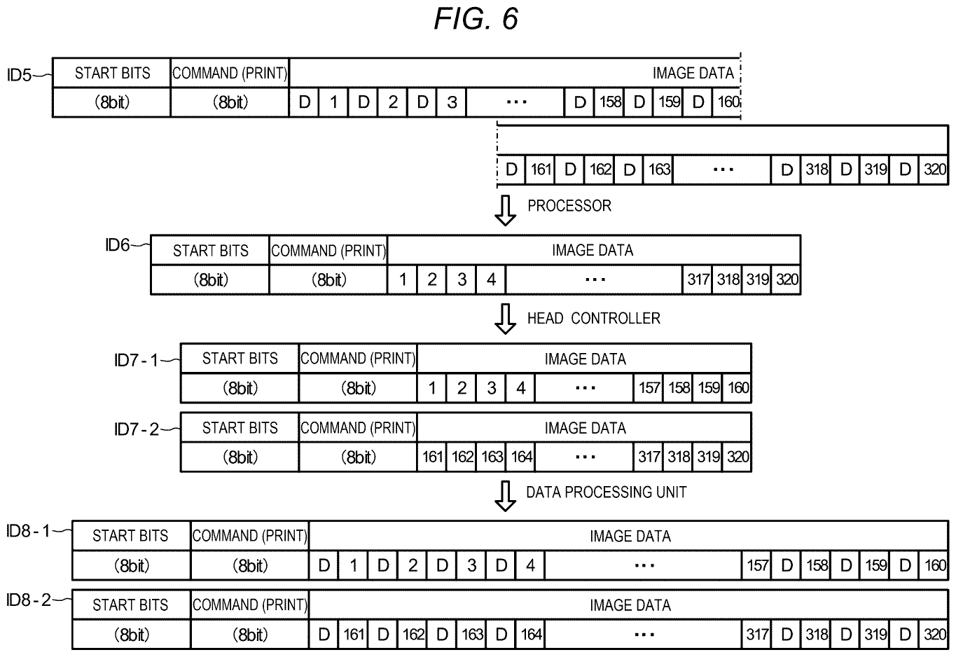

FIG. 6 is a transition diagram of another data format example of the print image data for explaining the operation of the inkjet head 19. FIG. 6 shows the print image data in which one line corresponds to 320 dots, and is an example when performing printing with two head units 25 via two drive circuits 27 each having 640 actuator output terminals. In this example, the head unit 25 has 320 nozzles each performing 1 dot printing, odd-numbered terminals out of the 640 actuator output terminals are not coupled to the nozzles of the head unit 25, and only even-numbered terminals are coupled to the nozzles of the head unit 25. Alternatively, it is possible to provide the head unit 25 to have no less than 321 nozzles, such as 640 nozzles, which is the same in the number as the 640 actuator output terminals of the drive circuit 27, and the nozzles are respectively coupled to the actuator output terminals, but only even-numbered 320 nozzles out of those nozzles are valid while the odd-numbered nozzles are the dummy nozzles which are not used, and only the drive signals which do not result in the actual drive of the actuators are output from the actuator output terminals corresponding to those dummy nozzles of the drive circuit 27.

When using the inkjet head 19 having such a configuration, the processor 22 of the inkjet printer 1 supplied such print image data as print image data ID5 to the head controller 20 in the related art. In the print image data ID5, an 8-bit print command representing the fact that the present data is print image data is disposed subsequently to 8-bit start bits, and image data to be printed which is the data substance is arranged subsequently thereto. In the image data, the dummy data D having the fixed value as the unused image data is set in the odd bits which are bits corresponding to the actuator output terminals which only output the drive signals which do not result in the actual drive of the actuators. The used image data corresponding to 320 dots corresponding to the nozzle numbers #1 to #320 is set to the even bits which output the drive signals making a contribution to the drive of the actuators.

In contrast, in the present first embodiment, the processor 22 generates print image data ID6 which does not include such dummy data D, and then supplies the print image data ID6 to the head controller 20. Then, the head controller 20 generates the print image data to be transmitted to each of the inkjet heads 19 from the print image data ID6. Specifically, the head controller 20 generates, for example, two print image data ID7-1, ID7-2 to be transferred to the inkjet head 19-1. The print image data ID7-1 is the print image data which is transmitted to the data transfer circuit 26-1 of the intra-head control circuit 24 of the inkjet head 19-1 via the inkjet head high-speed data transmission path DO11. The print image data ID7-2 is the print image data which is transmitted to the data transfer circuit 26-2 of the intra-head control circuit 24 of the inkjet head 19-1 via the inkjet head high-speed data transmission path DO12. The print image data ID7-1 includes the used image data corresponding to 160 dots corresponding to the nozzle numbers #1 to #160 subsequently to the 8-bit start bits and the 8-bit print command. The print image data ID 7-2 includes the used image data corresponding to 160 dots corresponding to the nozzle numbers #161 to #320 subsequently to the 8-bit start bits and the 8-bit print command. It should be noted that in the following description, the print image data ID7-1, ID7-2 is described simply as “print image data ID7” when describing the print image data ID7-1, ID7-2 without distinction.

In the intra-head control circuit 24 of the inkjet head 19 which receives such print image data ID7, the fact that the data input is the print image data ID7 is determined with the command analysis circuit 36, and the dummy data D having the fixed value as the unused image data is attached to the print image data ID7 with the data processing circuit 34.

Specifically, in the data processing circuit 34 of the data transfer circuit 26-1, when the analysis result from the command analysis circuit 36 is the print command, that is, when the data thus input is the print image data ID7-1, the data determination unit 48 transfers the data thus input to the unused image data attaching unit 51.

The unused nozzle number determination unit 49 outputs the nozzle number to the unused image data attaching unit 51 in accordance with the count from the data counter 37.

When the odd nozzle numbers which are the nozzle numbers set as the unnecessary nozzle numbers with the known information from the unused nozzle number determination unit 49 are input, the unused image data attaching unit 51 attaches the dummy data D having the fixed value as the unused image data stored in the fixed value storage unit 50 to the image data as the data substance of the print image data ID7-1 input from the data determination unit 48. In this way, the unused image data attaching unit 51 attaches the dummy data D corresponding to 160 dots corresponding to the odd nozzle numbers of the print image data ID7-1 to generate print image data ID8-1 in which the used image data is arranged to the 160 dots corresponding to the even nozzle numbers. The unused image data attaching unit 51 transfers the print image data ID8-1 to the drive circuit 27-1 via the data determination unit 52.

Similarly, in the data processing circuit 34 of the data transfer circuit 26-2, when the odd nozzle numbers which are the nozzle numbers set as the unnecessary nozzle numbers with the known information by the unused nozzle number determination unit 49 are input, the unused image data attaching unit 51 attaches the dummy data D having the fixed value as the unused image data stored in the fixed value storage unit 50 to the image data as the data substance of the print image data ID7-2 input from the data determination unit 48. In this way, the unused image data attaching unit 51 attaches the dummy data D corresponding to 160 dots corresponding to the odd nozzle numbers of the print image data ID7-2 to generate print image data ID8-2 in which the used image data is arranged to the 160 dots corresponding to the even nozzle numbers, and then transfers the print image data ID8-2 thus generated to the drive circuit 27-2 via the data determination unit 52.

As described above, the inkjet head 19 according to the first embodiment includes the head units 25 in which the plurality of actuators for ejecting the ink is arranged, the drive circuits 27 for driving the plurality of actuators of the head units 25 in accordance with the input data, and the data transfer circuits 26 for transmitting the input data to the drive circuits 27. The data transfer circuit 26 includes the data receiving circuit 33 which receives first print image data from the head controller 20 which is an outside of the inkjet head 19, the data processing circuit 34 which converts the first print image data thus received into second print image data larger in data amount than the first print image data, and the data transmitting circuit 35 which outputs the second print image data thus converted to the drive circuit 27 as the input data. As described above, in the inkjet head 19 according to the first embodiment, the first print image data less in data amount is transferred, then the first print image data is converted into second print image data having the data amount necessary for the drive circuit 27 in the inkjet head 19, and the second print image data is transmitted to the drive circuit 27 instead of transferring a large amount of print image data from the head controller 20 to the inkjet head 19 in a short time.

Therefore, according to the inkjet head 19 of the first embodiment, since substantially the same result as when transmitting the large amount of print image data in a short time can be obtained without actually transmitting the large amount of print image data in a short time, an increase in data transfer rate from the head controller 20 to the inkjet head 19 can be achieved at low cost.

It should be noted that in the inkjet head according to the first embodiment, the data processing circuit 34 has the unused image data attaching unit 51 which attaches the unused image data, which is not used when executing printing in the inkjet head 19, to the first print image data thus received to thereby convert the first print image data into the second print image data.

Therefore, according to the inkjet head 19 of the first embodiment, it is possible to transmit, from the head controller 20 to the inkjet head 19, the first print image data obtained by deleting the dummy data D having the fixed value as the unused image data which should be contained in the second print image data necessary for the drive circuit 27, and which is not used when executing printing in the inkjet head 19, and then attach the dummy data D to necessary places of the first print image data in the inkjet head 19.

It should be noted that in the inkjet head 19 according to the first embodiment, the drive circuit 27 has a plurality of first actuator output terminals which output the drive signals making a contribution to driving of the plurality of actuators of the head unit 25, and a plurality of second actuator output terminals which output the drive signals which do not result in driving of the plurality of actuators. The plurality of first actuator output terminals and the plurality of second actuator output terminals are fixed, and the unused image data attaching unit 51 converts the first print image data into the second print image data so that the drive signals based on the unused image data are output from the second actuator output terminals. Therefore, according to the inkjet head 19 of the first embodiment, it is possible to obtain the second print image data matching a configuration of the first and second actuator output terminals of the drive circuit 27 based on the first print image data.

Further, the intra-head control circuit 24 according to the first embodiment is disposed in the inkjet head 19 provided with the head units 25 in which the plurality of actuators for ejecting the ink is arranged, and includes the drive circuits 27 for driving the plurality of actuators of the head units 25 in accordance with the input data, and the data transfer circuits 26 for transmitting the input data to the drive circuits 27. The data transfer circuit 26 includes the data receiving circuit 33 which receives the first print image data from the head controller 20 which is an outside of the inkjet head 19, the data processing circuit 34 which converts the first print image data thus received into the second print image data larger in data amount than the first print image data, and the data transmitting circuit 35 which outputs the second print image data thus converted to the drive circuit 27 as the input data. As described above, in the intra-head control circuit 24 according to the first embodiment, the first print image data smaller in data amount is converted into the second print image data having the data amount necessary for the drive circuit 27, and then the second print image data is transferred to the drive circuit 27.

Therefore, according to the intra-head control circuit 24 of the first embodiment, since substantially the same result as when transmitting the large amount of print image data in a short time from the head controller 20 to the inkjet head 19 can be obtained without actually transmitting the large amount of print image data in a short time from the head controller 20 to the inkjet head 19, an increase in data transfer rate from the head controller 20 to the inkjet head 19 can be achieved at low cost.

Further, the inkjet head 19 according to the first embodiment includes first and second head units 25-1, 25-2 in which the plurality of actuators for ejecting the ink is arranged, and the intra-head control circuit 24 which controls the first and second head units 25-1, 25-2, the intra-head control circuit 24 includes a first drive circuit 27-1 which drives the first head unit 25-1 in accordance with first input data, a second drive circuit 27-2 which drives the second head unit 25-2 in accordance with second input data, a first data transfer circuit 26-1 which transfers, to the first drive circuit 27-1, the first input data input from the head controller 20 which is the outside of the inkjet head 19, a second data transfer circuit 26-2 which transfers, to the second drive circuit 27-2, the second input data input from the head controller 20, and an input-output circuit which transmits, to the first and second drive circuits 27-1, 27-2, signals input from the head controller 20, and the input-output circuit is provided with the clock signal input path 39 or the reset signal input path 41 through which a signal input from the head controller 20 is transmitted, the reset signal output path 42-1 coupled to the first drive circuit 27-1, the reset signal output path 42-2 coupled to the second drive circuit 27-2, and the clock receiving circuit 28, the frequency conversion circuit 29 and the clock transmitting circuit 38, or the reset generation circuit 30 which generates the data transmitting clock or the reset signal which controls the first and second drive circuits 27-1, 27-2 based on a signal transmitted through the clock signal input path 39 or the reset signal input path 41, and transmits the common data transmitting clock or the reset signal thus generated to the clock signal output path 40-1 and the clock signal output path 40-2, or the reset signal output path 42-1 and the reset signal output path 42-2.

Therefore, according to the inkjet head 19 of the first embodiment, by making it possible to coordinate the clock signal and the reset signal, which are necessary for each of the drive circuits 27-1, 27-2 but may be integrated into a single input or output signal for the inkjet head 19, with the head controller 20 and then input the clock signal and the reset signal thus coordinated to the inkjet head 19, and then separate the clock signal and the reset signal thus coordinated into the individual clock signals and the individual reset signals with the intra-head control circuit 24 to be input to the respective drive circuits 27, it is possible to reduce the number of input signals from the head controller 20 to the inkjet head 19. Therefore, according to the inkjet head 19 of the first embodiment, it becomes possible to cope with the plurality of drive circuits 27 without the growth in size of the connector of the inkjet head 19.

Here, the reset generation circuit 30 of the inkjet head 19 according to the first embodiment removes chattering of the reset signal which is input from the outside and is transmitted through the reset signal output path 42-1 and the reset signal output path 42-2.

Therefore, according to the inkjet head 19 of the first embodiment, the reset signal from which the chattering is removed can be input to each of the drive circuits 27, and thus, it is possible to stably reset each of the drive circuits 27.

Further, the inkjet head 19 according to the first embodiment includes the first and second head units 25-1, 25-2 in which the plurality of actuators for ejecting the ink is arranged, and the intra-head control circuit 24 which controls the first and second head units 25-1, 25-2, the intra-head control circuit 24 includes the first drive circuit 27-1 which drives the first head unit 25-1 in accordance with first input data, the second drive circuit 27-2 which drives the second head unit 25-2 in accordance with second input data, the first data transfer circuit 26-1 which transfers, to the first drive circuit 27-1, the first input data input from the head controller 20 which is the outside of the inkjet head 19, the second data transfer circuit 26-2 which transfers, to the second drive circuit 27-2, the second input data input from the head controller 20, and an input-output circuit which transmits, to the head controller 20, signals output from the first and second drive circuits 27-1, 27-2, and the input-output circuit is provided with the configuration recognition signal input path 43-1 coupled to the first drive circuit 27-1, the configuration recognition signal input path 43-2 coupled to the second drive circuit 27-2, the configuration recognition signal output path 45 through which a signal to be output to the head controller 20 is transmitted, and the configuration recognition signal generation circuit 31 which generates the configuration recognition signal representing states of the first and second drive circuits 27-1, 27-2 based on a signal from the first drive circuit 27-1 which is transmitted through the configuration recognition signal input path 43-1 and a signal from the second drive circuit 27-2 which is transmitted through the configuration recognition signal input path 43-2, and then transmits the configuration recognition signal thus generated to the configuration recognition signal output path 45.

Therefore, according to the inkjet head 19 of the first embodiment, by making it possible to coordinate the configuration recognition signal, which is necessary for each of the drive circuits 27-1, 27-2 but may be integrated into a single input or output signal for the inkjet head 19, with the intra-head control circuit 24 and then output the configuration recognition signal coordinated from the inkjet head 19, it is possible to reduce the number of output signals from the inkjet head 19 to the head controller 20. Therefore, according to the inkjet head 19 of the first embodiment, it becomes possible to cope with the plurality of drive circuits 27 without the growth in size of the connector of the inkjet head 19.

Further, the intra-head control circuit 24 according to the first embodiment is the intra-head control circuit 24 configured inside the inkjet head 19 provided with the first and second head units 25-1, 25-2 in which the plurality of actuators for ejecting the ink is arranged, and includes the first drive circuit 27-1 which drives the first head unit 25-1 in accordance with first input data, the second drive circuit 27-2 which drives the second head unit 25-2 in accordance with second input data, the first data transfer circuit 26-1 which transfers, to the first drive circuit 27-1, the first input data input from the head controller 20 which is the outside of the inkjet head 19, the second data transfer circuit 26-2 which transfers, to the second drive circuit 27-2, the second input data input from the head controller 20, and an input-output circuit which transmits, to the first and second drive circuits 27-1, 27-2, signals input from the head controller 20, and the input-output circuit is provided with the clock signal input path 39 or the reset signal input path 41 through which a signal input from the head controller 20 is transmitted, the reset signal output path 42-1 coupled to the first drive circuit 27-1, the reset signal output path 42-2 coupled to the second drive circuit 27-2, and the clock receiving circuit 28, the frequency conversion circuit 29 and the clock transmitting circuit 38, or the reset generation circuit 30 which generates the data transmitting clock or the reset signal which controls the first and second drive circuits 27-1, 27-2 based on a signal transmitted through the clock signal input path 39 or the reset signal input path 41, and transmits the common data transmitting clock or the reset signal thus generated to the clock signal output path 40-1 and the clock signal output path 40-2, or the reset signal output path 42-1 and the reset signal output path 42-2.

Therefore, according to the intra-head control circuit 24 of the first embodiment, by making it possible to coordinate the clock signal and the reset signal, which are necessary for each of the drive circuits 27-1, 27-2 but may be integrated into a single input or output signal for the inkjet head 19, with the head controller 20 and then input the clock signal and the reset signal thus coordinated to the inkjet head 19, and then separate the clock signal and the reset signal thus coordinated into the individual clock signals and the individual reset signals with the intra-head control circuit 24 to be input to the respective drive circuits 27, it is possible to reduce the number of input signals from the head controller 20 to the inkjet head 19. Therefore, according to the inkjet head 19 of the first embodiment, it becomes possible to cope with the plurality of drive circuits 27 without the growth in size of the connector of the inkjet head 19.

Further, the intra-head control circuit 24 according to the first embodiment is the intra-head control circuit 24 configured inside the inkjet head 19 provided with the first and second head units 25-1, 25-2 in which the plurality of actuators for ejecting the ink is arranged, and includes the first drive circuit 27-1 which drives the first head unit 25-1 in accordance with first input data, the second drive circuit 27-2 which drives the second head unit 25-2 in accordance with second input data, the first data transfer circuit 26-1 which transfers, to the first drive circuit 27-1, the first input data input from the head controller 20 which is the outside of the inkjet head 19, the second data transfer circuit 26-2 which transfers, to the second drive circuit 27-2, the second input data input from the head controller 20, and an input-output circuit which transmits, to the head controller 20, signals output from the first and second drive circuits 27-1, 27-2, and the input-output circuit is provided with the configuration recognition signal input path 43-1 coupled to the first drive circuit 27-1, the configuration recognition signal input path 43-2 coupled to the second drive circuit 27-2, the configuration recognition signal output path 45 through which a signal to be output to the head controller 20 is transmitted, and the configuration recognition signal generation circuit 31 which generates the configuration recognition signal representing states of the first and second drive circuits 27-1, 27-2 based on a signal from the first drive circuit 27-1 which is transmitted through the configuration recognition signal input path 43-1 and a signal from the second drive circuit 27-2 which is transmitted through the configuration recognition signal input path 43-2, and then transmits the configuration recognition signal thus generated to the configuration recognition signal output path 45.

Therefore, according to the intra-head control circuit 24 of the first embodiment, by making it possible to coordinate the configuration recognition signal, which is necessary for each of the drive circuits 27-1, 27-2 but may be integrated into a single input or output signal for the inkjet head 19, with the intra-head control circuit 24 and then output the configuration recognition signal coordinated from the inkjet head 19, it is possible to reduce the number of output signals from the inkjet head 19 to the head controller 20. Therefore, according to the inkjet head 19 of the first embodiment, it becomes possible to cope with the plurality of drive circuits 27 without the growth in size of the connector of the inkjet head 19.

Here, the configuration recognition signal generation circuit 31 of the inkjet head 19 according to the first embodiment removes chattering of the configuration recognition signal which is transmitted through the configuration recognition signal input paths 43-1, 43-2.

Therefore, according to the inkjet head 19 of the first embodiment, the configuration recognition signal from which the chattering is removed can be input from the inkjet head 19 to the head controller 20, and thus, it is possible to stably perform the state recognition of the drive circuits 27 in the head controller 20.

Further, the inkjet printer 1 according to the first embodiment includes the processor 22 which generates the print image data, and the inkjet head 19 which executes printing in accordance with the print image data transmitted from the processor 22. The processor 22 generates the second print image data by deleting the unused image data which is not used when executing printing in the inkjet head 19 from the first print image data corresponding to the image to be printed based on the configuration of the inkjet head 19, and then transmits the second print image data thus generated to the inkjet head 19, the inkjet head 19 includes the head unit 25 in which the plurality of actuators for ejecting the ink is arranged, the drive circuit 27 which drives the plurality of actuators of the head unit 25 in accordance with the input data, and the data transfer circuit 26 which transmits the input data to the drive circuit 27, and the data transfer circuit 26 includes the data receiving circuit 33 which receives the second print image data from the processor 22 as the outside of the inkjet head 19 via the head controller 20, the data processing circuit 34 which attaches the unused image data to the second print image data thus received to thereby convert the second print image data into the first print image data, and the data transmitting circuit 35 which outputs the first print image data thus converted to the drive circuit 27 as the input data. As described above, therefore, according to the inkjet printer 1 of the first embodiment, the second print image data obtained by deleting the dummy data D having the fixed value as the unused image data which should be contained in the first print image data necessary for the drive circuit 27, and which is not used when executing printing in the head unit 25 is transmitted from the processor 22 to the inkjet head 19 via the head controller 20, and then the dummy data D is attached to necessary places of the second print image data in the inkjet head 19 to thereby restore the original first print image data.

Therefore, according to the inkjet printer 1 of the first embodiment, since substantially the same result as when transmitting the large amount of print image data in a short time can be obtained without actually transmitting the large amount of print image data in a short time, an increase in data transfer rate from the processor 22 to the inkjet head 19 via the head controller 20 can be achieved at low cost.

### Second Embodiment

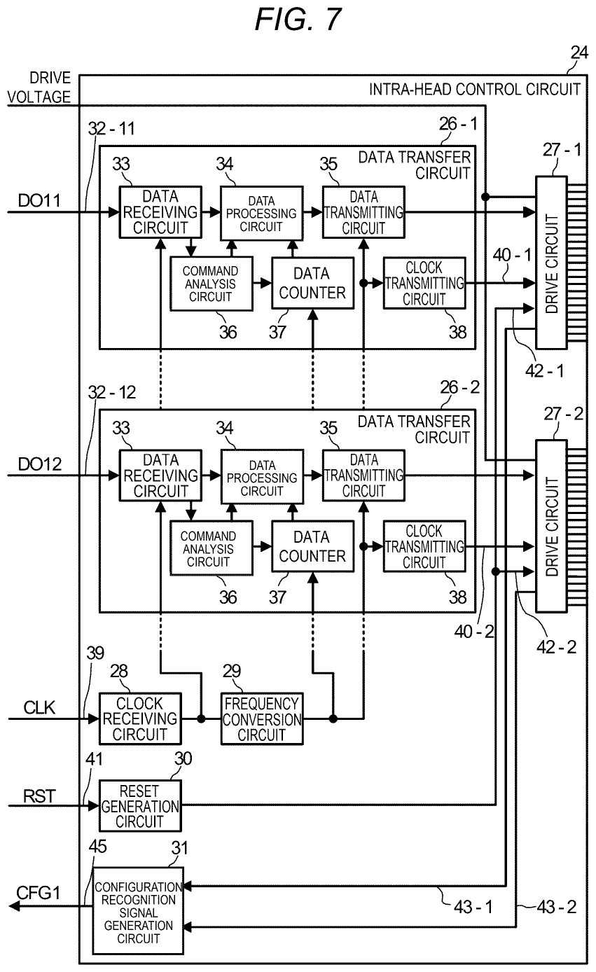

Then, a second embodiment will be described. Here, the description of the same part as that in the first embodiment will be omitted, and only parts different from those in the first embodiment will be described. FIG. 7 is a diagram of the intra-head control circuit 24 according to the second embodiment.

In the intra-head control circuit 24 according to the second embodiment, the configuration recognition signal output from the drive circuit 27-1 is input to the configuration recognition signal generation circuit 31 via the configuration recognition signal input path 43-1. Similarly, the configuration recognition signal output from the drive circuit 27-2 is input to the configuration recognition signal generation circuit 31 via the configuration recognition signal input path 43-2. In this way, the configuration recognition signals output respectively from the drive circuits 27-1, 27-2 are input to the configuration recognition signal generation circuit 31 via the individual configuration recognition signal input paths 43-1, 43-2.

Further, in the present second embodiment, the configuration recognition signal generation circuit 31 is configured as an AND circuit. Therefore, when all the configuration recognition signals are provided to the configuration recognition signal generation circuit 31, the configuration recognition signal generation circuit 31 outputs the configuration recognition signal to the configuration recognition signal output path 45 coupled to the configuration recognition signal receiving path CFG1 to the head controller 20. Thus, the inkjet head 19 notifies the head controller 20 of the fact that the initial setting is completed and the available state is achieved in all of the drive circuits 27 of that inkjet head 19.

As described above, in the inkjet head 19 according to the second embodiment and the intra-head control circuit 24 according to the second embodiment, the configuration recognition signal generation circuit 31 generates the configuration recognition signal and transmits the configuration recognition signal thus generated to the configuration recognition signal output path 45 when both the signal from the first drive circuit 27-1 and the signal from the second drive circuit 27-2 are obtained.

Therefore, according to the inkjet head 19 and the intra-head control circuit 24 of the second embodiment, it is possible to notify the head controller 20 of the completion of the configuration not by the drive circuit 27 but by the inkjet head 19.

### Third Embodiment

Then, a third embodiment will be described. Here, the description of the same part as that in the first and second embodiments will be omitted, and only parts different from those in the first and second embodiments will be described. In the first and second embodiments, which actuator output terminal does not output the print image data is uniquely determined by the head unit 25 provided to the inkjet head 19. In contrast, in the present third embodiment, which actuator output terminal does not output the print image data can appropriately be designated by the processor 22 of the inkjet printer 1.

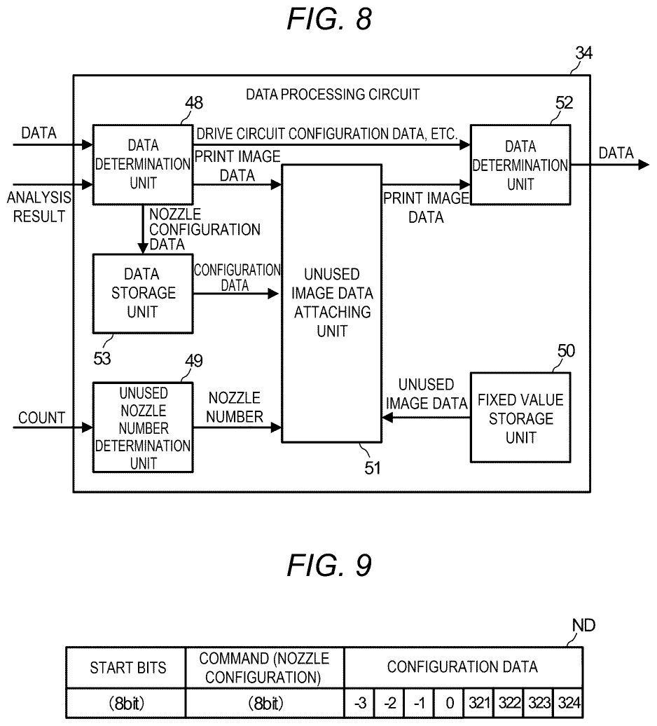

FIG. 8 is a diagram of the data processing circuit 34 of the data transfer circuit 26 in the intra-head control circuit 24 according to the third embodiment. In the present third embodiment, the data processing circuit 34 additionally includes a data storage unit 53 to the configuration shown in FIG. 4.

Here, in the present third embodiment, when the analysis result of the input data is nozzle configuration data, the data determination unit 48 transfers, to the data storage unit 53, the nozzle configuration data which is input from the data receiving circuit 33, that is, from the processor 22 of the inkjet printer 1 via the head controller 20.

FIG. 9 is a diagram showing a data format example of the nozzle configuration data ND. In the nozzle configuration data ND, an 8-bit nozzle configuration command representing the fact that the present data is the nozzle configuration data is disposed subsequently to 8-bit start bits, and configuration data which is the data substance is arranged subsequently thereto. In the example shown in FIG. 9, the nozzle numbers #-3 to #0 and the nozzle numbers #321 to #324 which designate anterior nozzles and posterior nozzles to the nozzles designated by the nozzle numbers #1 to #320 are set as the configuration data. This is an example when causing the unused image data attaching unit 51 of the data transfer circuit 26-1 in the intra-head control circuit 24 of the inkjet head 19-1 to generate the print image data ID4-1 shown in FIG. 5.

The data storage unit 53 stores the configuration data as the data substance in the nozzle configuration data ND transferred from the data determination unit 48. For example, the data storage unit 53 can be configured as a register or a random access memory (RAM). The data storage unit 53 holds the configuration data until new data is input, and inputs the configuration data held therein to the unused image data attaching unit 51.

In the present third embodiment, the unused image data attaching unit 51 is provided with the number of actuators of the head unit 25, that is, the number of nozzles, as the known information.

The unused image data attaching unit 51 selects either one of the print image data input from the data determination unit 48 and the unused image data input from the fixed value storage unit 50 based on the nozzle number input from the unused nozzle number determination unit 49, the configuration data stored in the data storage unit 53, and the known information, and then transfers the image data thus selected to the data determination unit 52 as the print image data. Specifically, the unused image data attaching unit 51 determines the nozzle number corresponding to the unnecessary nozzle number based on the configuration data stored in the data storage unit 53. In the example shown in FIG. 9, it is determined that the nozzle numbers #1 to #4, and the nozzle numbers #325 to #328 are the unnecessary nozzle numbers. Therefore, when the nozzle numbers #1 to #4 are input from the unused nozzle number determination unit 49, the unused image data attaching unit 51 transfers the fixed value as the unused image data input from the fixed value storage unit 50 to the data determination unit 52 as the print image data. When the nozzle numbers #5 to #324 are input from the unused nozzle number determination unit 49, the unused image data attaching unit 51 transfers the print image data input from the data determination unit 48 to the data determination unit 52 as the print image data. Then, when the nozzle numbers #325 to #328 are input from the unused nozzle number determination unit 49, the unused image data attaching unit 51 transfers the fixed value as the unused image data input from the fixed value storage unit 50 to the data determination unit 52 as the print image data. In this way, when the nozzle number coincides with the unnecessary nozzle number, the unused image data attaching unit 51 attaches the unused image data as the fixed value to the print image data.

It should be noted that when causing the unused image data attaching unit 51 of the data transfer circuit 26-1 in the intra-head control circuit 24 of the inkjet head 19-1 to generate the print image data ID8-1 shown in FIG. 6, it is sufficient to set a predetermined configuration value representing that the unnecessary nozzle numbers are the even nozzle numbers to the configuration data as the data substance in the nozzle configuration data ND.

As described above, in the inkjet head 19 according to the third embodiment and the intra-head control circuit 24 according to the third embodiment, the drive circuit 27 has a plurality of first actuator output terminals which output the drive signals making a contribution to the drive of the plurality of actuators of the head unit 25, and a plurality of second actuator output terminals which output the drive signals which do not result in the drive of the plurality of actuators, the data processing circuit 34 is further provided with the data determination unit 48 and the data storage unit 53 which sets the plurality of second actuator output terminals in response to the configuration from the head controller 20 located outside, and the unused image data attaching unit 51 converts the first print image data into the second print image data so that the drive signals based on the unused image data are output from the second actuator output terminals.

Therefore, according to the inkjet head 19 and the intra-head control circuit 24 according to the third embodiment, it is possible to set the second actuator output terminal which outputs the drive signal which does not result in the drive of the actuator of the head unit 25 from the outside.

### Fourth Embodiment

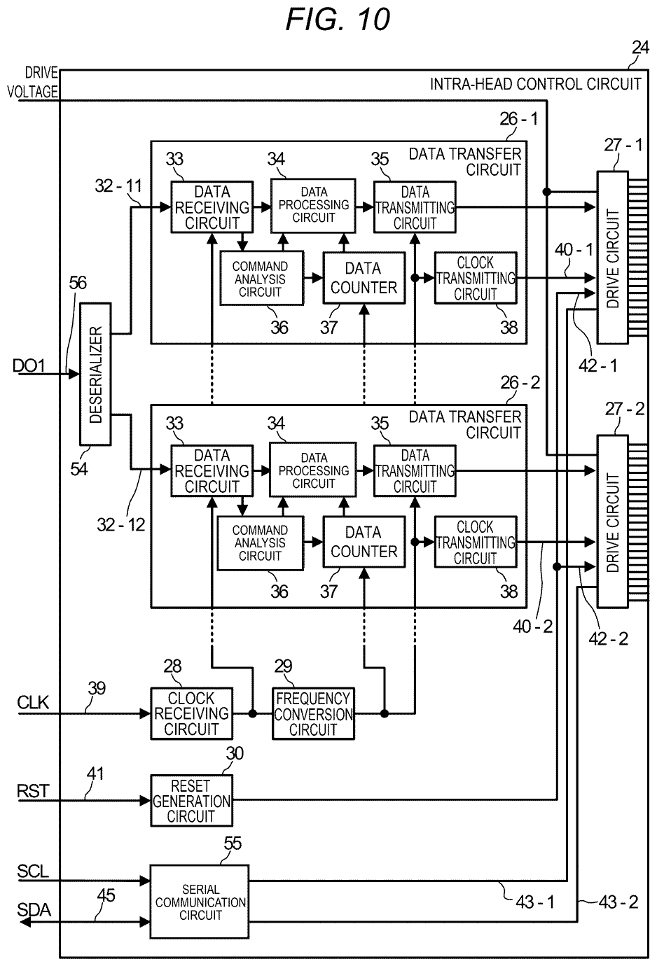

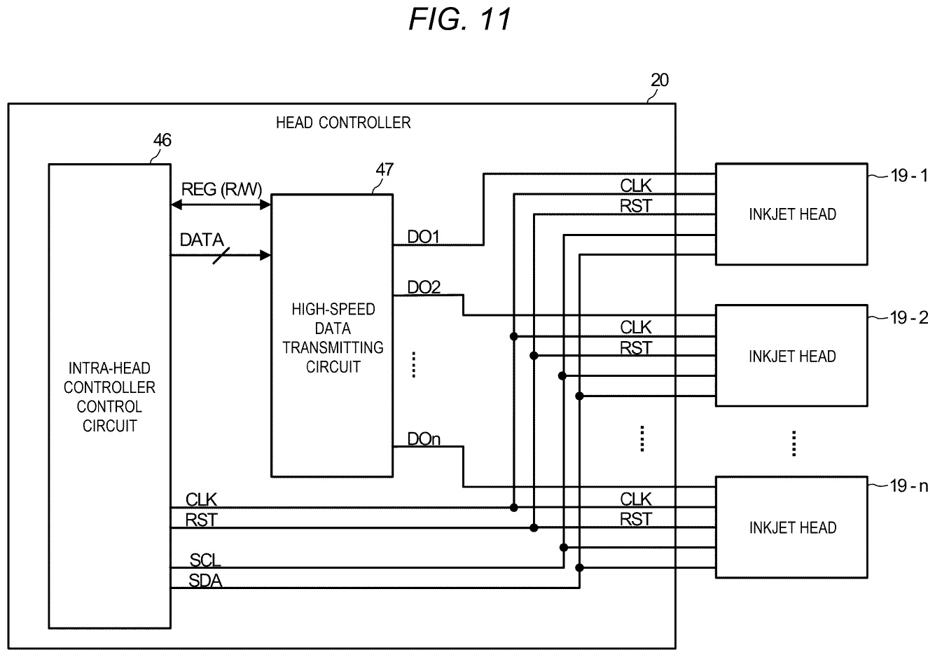

Then, a fourth embodiment will be described. Here, the description of the same part as that in the first to third embodiments will be omitted, and only parts different from those in the first to third embodiments will be described. FIG. 10 is a diagram of the intra-head control circuit 24 according to the fourth embodiment, and FIG. 11 is a diagram of the head controller 20 according to the fourth embodiment. It should be noted that FIG. 10 shows the intra-head control circuit 24 of the inkjet head 19-1.

As shown in FIG. 10, the intra-head control circuit 24 according to the present fourth embodiment includes a deserializer 54 in an anterior stage of the data transfer circuits 26-1, 26-2. Further, in the intra-head control circuit 24 according to the present fourth embodiment, the reset signal output paths 42-1, 42-2 from the drive circuits 27-1, 27-2 are coupled to a serial communication circuit 55.

The deserializer 54 receives data, which is transmitted from the head controller 20 via the inkjet head high-speed transmission path DO1, via the data input path 56 coupled to the inkjet head high-speed transmission path DO1 from the head controller 20. As shown in FIG. 11, in the present embodiment, the high-speed data transmitting circuit 47 of the head controller 20 coordinates the data transmitted using the inkjet head high-speed data transmission paths DOi1, DOi2 in the first to third embodiments, and transmits the data thus coordinated using the inkjet head high-speed data transmission paths DOi. Therefore, the deserializer 54 reconstitutes the data thus coordinated into two data. Then, the deserializer 54 transmits one datum to the data transfer circuit 26-1 through the data input path 32-11, and transmits the other datum to the data transfer circuit 26-2 through the data input path 32-12.

Further, the serial communication circuit 55 is a serial communication unit for performing serial communication (e.g., Inter-Integrated Circuit (I2C), Serial Peripheral Interface (SPI), and so on). For example, the serial communication circuit 55 is coupled to two signal lines of a serial clock SCL and a serial data SDA constituting a serial communication path. The coupling to the serial data SDA forms the configuration recognition signal output path. The serial clock SCL and the serial data SDA constituting the serial communication path are coupled to the head controller 20. In the head controller 20, as shown in FIG. 11, the serial clocks SCL to the serial communication units 55 of the respective inkjet heads 19 are commonly coupled, and further, the serial data SDA are commonly coupled, and are respectively coupled to the intra-head controller control circuits 46. The serial communication circuit 55 attaches device addresses for identifying the drive circuits 27 to the configuration recognition signals from the drive circuits 27, and then transmits the configuration recognition signals attached with the device addresses to the head controller 20. Therefore, the head controller 20 can easily determine the configuration recognition signal is originated at which drive circuit 27 of which inkjet head 19 based on the device address.

As described above, the inkjet head 19 according to the fourth embodiment and the intra-head control circuit 24 according to the fourth embodiment are provided with the data input path 56 through which data such as the drive circuit configuration data and the print image data are transmitted, and the deserializer 54 which separates the data transmitted through the data input path 56 into the input data of the first data transfer circuit 26-1 which transmits the input data to the first drive circuit 27-1 and the input data of the second data transfer circuit 26-2 which transmits the input data to the second drive circuit 27-2.

Therefore, according to the inkjet head 19 and the intra-head control circuit 24 of the fourth embodiment, it is possible to reduce the number of the connectors which receives data such as the drive circuit configuration data and the print image data from the head controller 20.

Further, the inkjet head 19 according to the fourth embodiment and the intra-head control circuit 24 according to the fourth embodiment include the serial communication circuit 55 which performs the serial communication of the configuration recognition signal transmitted from the first drive circuit 27-1 through the configuration recognition signal input path 43-1 and the configuration recognition signal transmitted from the second drive circuit 27-2 through the configuration recognition signal input path 43-2 to the head controller 20.

Therefore, according to the inkjet head 19 and the intra-head control circuit 24 of the fourth embodiment, it is possible to individually notify the head controller 20 of the state signal representing the state of each of the drive circuits 27.

The first to fourth embodiments are hereinabove described, but the embodiments are not limited to the embodiments described above.

For example, it is assumed that each of the inkjet heads 19 has the two head units 25, but the number of head units 25 provided to each of the inkjet heads 19 may be three or more. Further, conversely, the number of head units 25 provided to each of the inkjet heads 19 may be one.

Although some embodiments are described, these embodiments are illustrative only, but limiting the scope of the disclosure is not intended. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. An inkjet head comprising:
a plurality of actuators each configured to eject ink through a corresponding one of nozzles, the actuators including first actuators corresponding to first nozzles that are enabled to eject ink and second actuators corresponding to second nozzles that are disabled from ejecting ink;
a drive circuit configured to drive the actuators in accordance with input data; and
a data transfer circuit configured to:
acquire first image data associating each of the first nozzles with images to be formed,
add, to the first image data, dummy image data associated with the second nozzles, and
output the first image data to which the dummy image data has been added to the drive circuit as the input data.

2. The inkjet head according to claim 1, wherein
the data transfer circuit acquires the first image data from a head controller that controls the inkjet head.

3. The inkjet head according to claim 2, further comprising:
a signal receiving path that carries a signal notifying the head controller that an initial setting of the drive circuit has been completed.

4. The inkjet head according to claim 1, wherein
the drive circuit includes a plurality of first terminals connected to the first actuators, and
the drive circuit drives the first actuators in accordance with the first image data of the input data.

5. The inkjet head according to claim 4, wherein
the drive circuit further includes a plurality of second terminals connected to the second actuators.

6. The inkjet head according to claim 1, wherein
the data transfer circuit is configured to, upon receipt of configuration data, determine which of the actuators are the second actuators with which the dummy data are associated.

7. The inkjet head according to claim 1, wherein
the first image data include two sets of print commands, corresponding respectively to first and second halves of the first nozzles.

8. A control circuit for controlling a plurality of actuators of an inkjet head to eject ink through nozzles, the actuators including first actuators corresponding to first nozzles that are enabled to eject ink and second actuators corresponding to second nozzles that are disabled from ejecting ink, the control circuit comprising:
a drive circuit configured to drive the actuators in accordance with input data; and
a data transfer circuit configured to:
acquire first image data associating each of the first nozzles with images to be formed,
add, to the first image data, dummy image data associating each of the second nozzles with dummy data, and
output the first image data to which the dummy image data has been added to the drive circuit as the input data.

9. The control circuit according to claim 8, wherein
the data transfer circuit acquires the first image data from a head controller that controls the inkjet head.

10. The control circuit according to claim 9, further comprising:
a signal receiving path that carries a signal notifying the head controller that an initial setting of the drive circuit has been completed.

11. The control circuit according to claim 8, wherein
the drive circuit includes a plurality of first terminals connected to the first actuators, and
the drive circuit drives the first actuators in accordance with the first image data of the input data.

12. The control circuit according to claim 11, wherein
the drive circuit further includes a plurality of second terminals connected to the second actuators.

13. The control circuit according to claim 8, wherein
the data transfer circuit is configured to, upon receipt of configuration data, determine which of the actuators are the second actuators with which the dummy data are associated.

14. The control circuit according to claim 8, wherein
the first image data include two sets of print commands, corresponding to first and second halves of the first nozzles.

15. An inkjet printer comprising:
a head controller; and
an inkjet head connected to the head controller and including:
a plurality of actuators each configured to eject ink through a corresponding one of nozzles, the actuators including first actuators corresponding to first nozzles that are enabled to eject ink and second actuators corresponding to second nozzles that are disabled from ejecting ink,
a drive circuit configured to drive the actuators in accordance with input data, and
a data transfer circuit, wherein
the head controller is configured to generate first image data associating each of the first nozzles with images to be formed, and
the data transfer circuit is configured to:
acquire the first image data from the head controller,
add, to the first image data, dummy image data associated with the second nozzles, and
output the first image data to which the dummy image data has been added to the drive circuit as the input data.

16. The inkjet printer according to claim 15, wherein
the head controller generates the first image data to include two sets of print commands, corresponding to first and second halves of the first nozzles.

17. The inkjet printer according to claim 15, wherein
the inkjet head includes a signal receiving path that carries a signal notifying the head controller that an initial setting of the drive circuit has been completed.

18. The inkjet printer according to claim 15, wherein
the drive circuit includes a plurality of first terminals connected to the first actuators, and
the drive circuit drives the first actuators in accordance with the first image data of the input data.

19. The inkjet printer according to claim 18, wherein
the drive circuit further includes a plurality of second terminals connected to the second actuators.

20. The inkjet printer according to claim 15, wherein
the data transfer circuit is configured to, upon receipt of configuration data, determine which of the actuators are the second actuators with which the dummy data are associated.
